(19) United States
(12) Patent Application Publication
(10) Pub. No.: US 2006/0145369 A1
(43) Pub. Date: Jul. 6, 2006

(54) Non-optical multi-piece core assembly for rapid tool change

(76) Inventors: Bruce E. Lawton, Rochester, NY (US); Thomas G. Jones, Rochester, NY (US)

Correspondence Address: Bausch & Lomb Incorporated, One Bausch & Lomb Place, Rochester, NY, 14604-2701, US

(21) Appl. No.: 11/026,620

(22) Filed: Dec. 30, 2004

(51) Int. Cl. B29D 11/00

(52) U.S. Cl. 264/1.32; 264/2.5; 425/808

(57) ABSTRACT

An apparatus and method is provided for injection molding an ophthalmic lens mold. The apparatus includes an optical tool assembly having an optical molding surface for forming an optical surface of the ophthalmic lens mold. A non-optical tool assembly is in opposed relation to the optical tool assembly and together therewith forms a mold cavity for forming the ophthalmic lens mold. The non-optical tool assembly includes a core member and a non-optical tool insert removably secured to the core member. The non-optical tool insert has a first molding surface for forming a surface of the ophthalmic lens mold opposite the optical surface.

### RELATED APPLICATION

This application is related to the U.S. patent applications entitled, respectively, “OPTICAL TOOL ASSEMBLY FOR IMPROVED RCW AND LENS EDGE FORMATION” (Attorney Docket No. P03453), “CORE LOCKING ASSEMBLY AND METHOD FOR ORIENTATION OF ASYMMETRICAL TOOLING” (Attorney Docket No. P03455) and “OPTICAL TOOL ASSEMBLY” (Attorney Docket No. P03456); all filed concurrently herewith, commonly assigned to Bausch & Lomb Incorporated and expressly incorporated herein by reference.

### BACKGROUND

The present disclosure relates to the molding of articles of manufacture. More particularly, the disclosure relates to an improved core assembly for injection molding performs or mold sections used in the manufacture of ophthalmic lenses, such as contact lenses and intraocular lenses, and will be described with particular reference thereto. It is to be appreciated, however, that the improved core assembly and apparatus related thereto may have utility in a variety of other similar environments and applications.

One method in practice for making ophthalmic lenses, including contact lenses and intraocular lenses, is cast molding. Cast molding of ophthalmic lenses involves depositing a curable mixture of polymerizable lens materials, such as monomers, in a mold cavity formed by two assembled mold sections, curing the mixture, disassembling the mold sections and removing the molded lens. Other post-molding processing steps, for example, hydration in the case of hydrogel lenses, may also be employed. Representative cast molding methods are disclosed in U.S. Pat. No. 5,271,875 (Appleton et al.); U.S. Pat. No. 4,197,266 (Clark et al.); U.S. Pat. No. 4,208,364 (Shepherd); U.S. Pat. No. 4,865,779 (Ihn et al.); U.S. Pat. No. 4,955,580 (Seden et al.); U.S. Pat. No. 5,466,147 (Appleton et al.); and U.S. Pat. No. 5,143,660 (Hamilton et al.).

When cast molding between a pair of mold sections, typically one mold section, referred to as the anterior mold section or preform, forms the anterior convex, optical surface of the ophthalmic lens and the other mold section, referred to as the posterior mold section or preform, forms the posterior concave, optical surface of the ophthalmic lens. The anterior and posterior mold sections are generally complimentary in configuration. They are joined together during the molding process to form a lens forming or molding cavity. Once the lens is formed, the mold sections or preforms are separated and the molded lens is removed. The anterior and posterior mold sections are usually used only once for casting a lens prior to being discarded due to the significant degradation of the optical surfaces of the mold sections that often occurs during a single casting operation.

Formation of the mold sections used in casting of the lens occurs through a separate molding process prior to cast molding of the lens. In this regard, the mold sections are first formed by injection molding a resin in the cavity of an injection molding apparatus. More particularly, mounted in the injection molding apparatus are tools for forming the mold sections. Typically, the tools are fitted into mold plates in the injection molding machine and the mold sections are produced by injection molding a selected resin between opposed sets of injection molding tools. The tools are typically made from brass, stainless steel, nickel, or some combination thereof and, unlike the mold sections which are used only once, the injection molding tools are used again and again to make large quantities of mold sections.

The injection molding tools are typically formed in accordance with the specification of corresponding ophthalmic lens surfaces to be formed on or by the mold sections. That is, the ophthalmic lens being produced determines the specific design of the mold sections. The needed mold section parameters, in turn, determine the design of the corresponding injection molding tools. The injection molding tools are typically manufactured to extremely high specifications and/or tolerances so that no roughness or surface defects are transferred to the mold sections being made from the tools. Any such defects on the mold sections, particularly on an optical surface of a mold section, is likely to be transferred to, and appear on, the finished lens during the cast molding operation.

Each mold section, whether it be a posterior mold section or an anterior mold section, includes an optical surface (posterior optical surface on a posterior mold section and anterior optical surface on an anterior mold section) that forms a surface of the ophthalmic lens, as well as a non-optical surface. When injection molding the mold section, the injection molding apparatus typically includes an optical tool assembly for forming the optical surface of the mold section and a non-optical tool assembly for forming the non-optical surface of the mold section. Prior improvements to the process of injection molding ophthalmic mold sections have yielded optical tool assemblies that employ a readily changeable optical tool insert for forming the optical surface of the mold section. Rapid changeability of the optical tool insert enables molding of a wider range of mold sections that can then be used to produce lenses having varying powers (i.e., varying diopters) without requiring significant downtime of the injection molding apparatus for tooling changes.

When an optical tool insert is changed for purposes of producing lenses of varying powers, the thickness profile of the lens, as well as the corresponding mold section (or sections), is altered so that lenses of various powers can be produced. If only the optical tool insert is changed to vary the power of the lens (i.e., the non-optical tool assembly and its non-optical molding surface remains unchanged), the thickness profile of the lens and the corresponding mold section (or sections) often changes nonuniformly. Although uniform wall thickness is desirable, slight nonuniformity in wall thickness is usually acceptable. Typically, the more significant the change in the optical tool inserts, the greater the nonuniformity becomes. If the thickness nonuniformity rises above a predetermined acceptable level or tolerance, the lenses cannot be used.

One solution for maintaining uniform cavity wall thicknesses after an optical tool insert is changed is to make a corresponding change to the non-optical tool assembly. However, this is often not a feasible solution due to the injection molding apparatus downtime required for changing conventional non-optical tool assemblies. The downtime associated with such non-optical tooling changes occurs because conventional non-optical tool assemblies typically have a unitary core member. The unitary core member has a non-optical molding surface for forming the non-optical surface of the injection molded mold sections and a water-cooling cavity defined therein that is in fluid communication with cooling lines of the injection molding apparatus.

The unitary nature of the core member necessitates substitution thereof as the only means for effecting desired changes to the non-optical molding surface. Alternatively stated, to change the non-optical molding surface, the entire core member is replaced with another core member having the desired non-optical molding surface. This can cause significant downtime and expense. Specific examples of what is required to change a unitary core member include the steps of disabling fluid communication with the cooling lines (i.e., shut-off of the cooling lines), draining the water-cooling cavity (and possibly the entire cooling system), removing the original core member and installing the replacement core member. These can be time consuming procedures and often result in significant downtime of the injection molding apparatus.

### BRIEF SUMMARY

According to one aspect, an apparatus and method is provided for injection molding an ophthalmic lens mold. More particularly, in accordance with this aspect, the apparatus includes an optical tool assembly having an optical molding surface for forming an optical surface of the ophthalmic lens mold. A non-optical tool assembly is in opposed relation to the optical tool assembly and together therewith forms a mold cavity for forming the ophthalmic lens mold. The non-optical tool assembly includes a core member and a non-optical tool insert removably secured to the core member. The non-optical tool insert has a first molding surface for forming a surface of the ophthalmic lens mold opposite the optical surface.

According to another aspect, an injection molding apparatus is provided for forming a mold section which is subsequently used for forming an ophthalmic lens. More particularly, in accordance with this aspect, the injection molding apparatus includes a cavity ring mounted to an associated first mold plate. An optical tool insert is removably mounted to the cavity ring. The optical tool insert has a molding surface with an optical quality finish. A core member is mounted to an associated second mold plate opposite the associated first mold plate. The non-optical tool insert is removably mounted to the core member. The non-optical tool insert has a first molding surface for forming a surface of the mold section opposite the optical surface.

According to yet another aspect, a non-optical tool assembly is provided for use in an injection molding apparatus opposite an optical tool assembly to form a ophthalmic mold section. More particularly, in accordance with this aspect, the non-optical tool assembly includes a core member mounted to an associated mold plate of the injection molding apparatus and having a cooling cavity fluidly connected to at least one associated fluid line of the injection molding apparatus. A non-optical tool insert is separate from the core member and removably secured thereto. The non-optical tool insert has a first molding surface for forming a surface of the ophthalmic mold section opposite an optical surface thereof.

According to still another aspect, a method for forming an ophthalmic lens is provided. More particularly, in accordance with this aspect, an injection molding apparatus is provided having an optical tool assembly with an optical mold surface for forming an optical surface of an anterior mold section and a non-optical tool assembly in opposed-relation to the optical tool assembly. The optical tool assembly and the non-optical tool assembly together forming a mold cavity. The non-optical mold assembly includes a core member and a non-optical tool insert removably secured to the core member. The non-optical tool insert has a first molding surface for forming a surface of the anterior mold section opposite the optical surface. The anterior mold section is injection molded in the mold cavity. The molded anterior mold section is removed from the mold cavity. The anterior mold section is matched with a posterior mold section. An ophthalmic lens is cast molded between the anterior mold section and the posterior mold section.

### BRIEF DESCRIPTION OF THE DRAWINGS

FIG. 1 is a schematic exploded view of a representative mold section assembly.

FIG. 2 is a schematic cross-sectional view of an injection molding arrangement having tooling (including an anterior core member and a non-optical tool insert) for injection molding an anterior mold section of the mold assembly shown in FIG. 1.

FIG. 3 is a perspective view of the non-optical tool insert of FIG. 2.

FIG. 4 is a perspective view of the anterior core member of FIG. 2.

### DETAILED DESCRIPTION

Referring now to the drawings wherein the showings are for purposes of illustrating one or more embodiments and not for purposes of limiting the same, a representative mold assembly is shown in FIG. 1 and generally designated by reference numeral 10. The mold assembly 10 includes an anterior mold preform or section 12 and a posterior mold preform or section 14. When mold sections 12 and 14 are assembled, optical surfaces 16,18 of the mold sections 12,14 define a mold cavity in which an ophthalmic lens 20 is formed, such as by cast molding. The ophthalmic lens 20 can be, for example, a contact lens or intraocular lens. The optical surface 16, also referred to herein as an anterior molding surface, is a concave surface formed atop the mold section 12 opposite non-optical surface 22. The optical surface 18 of the mold section 14, also referred to herein as a posterior molding surface, is a convex surface formed opposite non-optical surface 24. In the illustrated mold assembly 10, mold sections 12 and 14 additionally include respective cylindrical walls 26,28 and segment walls 30,32 that nest (but not necessarily touch or contact one another) when the mold sections are fully assembled.

As will be described in more detail below, each of the mold sections 12,14, also referred to herein as ophthalmic lens molds, can be injection molded from a plastic resin, such as polypropylene, polyvinyl chloride (PVC) or polystyrene, for example, in a full injection molding apparatus (not shown). As will be understood by those skilled in the art, the injection molded sections 12,14 can then be used in a cast molding process wherein a curable lens material, such as a liquid polymerizable monomer mixture, is introduced onto anterior molding surface 16, the mold sections 12,14 are brought into close association with the liquid being compressed to fill the mold cavity formed between the sections 12,14, and the monomer mixture is cured into an ophthalmic lens, such as contact lens 20 shown in the illustrated embodiment. It is noted that the mold sections shown herein are for purposes of description only, it being understood that the mold sections may have a variety of overall geometries to cast lenses of any desired type and configuration.

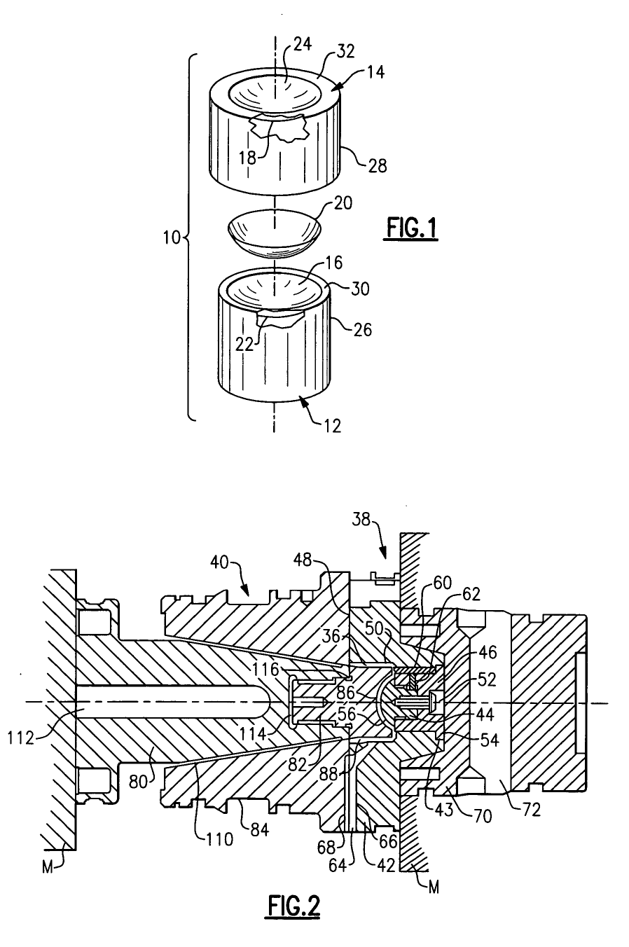

As will be understood by those skilled in the art, tools assemblies are mounted in the injection molding apparatus for forming the mold sections 12,14 by injection molding. The tool assemblies are mounted to and/or fitted into mold plates M (FIG. 2) of the injection molding apparatus and the mold sections 12,14 are formed by injection molding a selected resin in a cavity formed between opposed sets of tool assemblies. With additional reference to FIG. 2, only tool assemblies for forming the anterior mold section 12 will be described in further detail herein. However, it will be appreciated by those skilled in the art that the embodiment or embodiments discussed herein are easily adaptable for formation of the posterior mold section 14 and both are considered within the scope of the invention both individually and collectively.

In FIG. 2, a mold cavity 36 is formed between opposed tool assemblies, including optical tool assembly 38 and non-optical tool assembly 40, in which the mold section 12 of FIG. 1 can be formed. As illustrated, the optical tool assembly 38 forms the optical surface 16 of the mold section 12 and the non-optical tool assembly 40 forms non-optical surface 22 (FIG. 1) on an opposite side of the surface 16. The tool assemblies 38,40 also combine to form the cylindrical wall 26 and the segment wall 30 of the mold section 12.

The optical tool assembly 38 includes a cavity ring 42 and an optical tool insert 44 mounted to the cavity ring. More specifically, the insert 44 mounts within a body 46 which is itself mounted within the cavity ring 42. The cavity ring 42 mates with the non-optical tool assembly 40 along a parting line 48 to form the closed mold cavity 36. The cavity ring 42 and the body 46 together define a molding surface 50 that forms an outer surface of the cylindrical wall 26 and the segment wall 30. The optical tool insert 44 and the body 46 are removably secured together by a suitable fastener, such as threaded cap screw 52. Likewise, the cavity ring 42 is secured to the adjacent mold plate M of the injection molding apparatus by suitable fasteners, such as cap screws (not shown). The body 46 with the optical tool 44 secured thereto is axially secured by radial portion 54 mating within a counterbore 43 of the cavity ring 42.

The optical tool insert 44 includes optical molding surface 56 which has an optical quality finish to form the anterior molding optical surface 16 of the mold section 12. As used herein, the term “optical quality finish” denotes a molding surface that is sufficiently smooth for forming optical surface 16 which ultimately forms the optical surface of ophthalmic lens 20, e.g., the produced lens is suitable for placement in the eye without the need to machine or polish the formed lens surface. The insert 44 can be one of a set or series of inserts (not shown) and the removeability of the insert 44 enables it to be readily changed with another insert from the set of inserts. Each of the inserts in the set can have a different optical molding surface for purposes of ultimately molding lenses having differing optical powers.

A clocking dowel 60 is used to rotatably align the body 46 and the insert 44. A molding dowel 62 is used to mold an indicating mark on the mold section 12 for purposes of showing its alignment relative to the molding insert 44 and to secure the body 46 to the cavity ring 42. A runner or sprue 64 is disposed between the tool assemblies 38,40 and fluidly connected to the mold cavity 36 for allowing molten resin to be injected into the cavity 36 when injection molding the mold section 12. In the illustrated embodiment, the runner 64 connects to the cavity 36 along a portion thereof that forms the cylindrical wall 26 and thereby does not interfere with molding of the optical surface 16. The runner is formed by a first channel 66 defined in the cavity ring 42 and a second channel 68 formed in tool assembly 40, which is aligned with the first channel.

As known and understood by those skilled in the art, the optical tool assembly 38 can additionally include a water jacket 70 having a cooling cavity 72 adjacent the cavity ring 42 for cooling purposes. The cavity ring 42, insert 44 and body 46 can be formed, for example, of brass, stainless steel, nickel or some combination thereof. The molding surfaces 50,56 can be formed according to methods generally known to those skilled in the art, such as for example lathe cutting or electrodischarge machining. The optical molding surface 56 can additionally be polished to achieve precision surface quality so that no, or only insignificant, surface imperfections are transferred to the mold section 12.

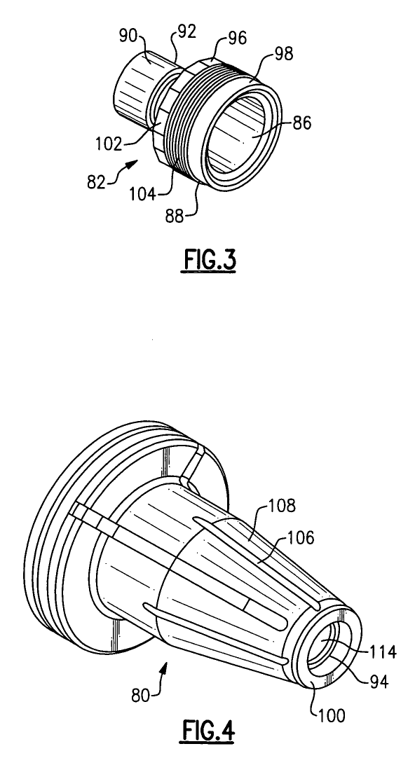

With additional reference to FIGS. 3 and 4, the non-optical tool assembly 40 includes a core member 80, a non-optical tool insert or cap 82 and a stripper member 84 (FIG. 2—which can be a stripper plate or sleeve, for example) annularly received about the core member. In the illustrated embodiment, the stripper member 84 includes the runner channel 68 that in part defines the runner 64. The non-optical tool insert 82 includes a first molding surface 86 that forms the surface 22 opposite the optical surface 16 of the molding section 12 and a second molding surface 88 that forms an inner surface of the cylindrical wall 26 and an inner surface of the segment wall 30. The non-optical tool insert 82 is removably secured to the core member 80. Optionally, O-ring 116 is disposed annularly about the insert 82 to seal between the insert 82 and the core member 80.

Specifically, and as seen best in FIG. 3, the insert 82 includes a shaft portion 90 having threads 92 thereon. The shaft portion 90 is received in a bore 114 defined in a distal end of the core member 80 and the threads 92 threadedly engage internal threads 94 (FIG. 4) defined in the bore 114. A shoulder 96, defined on the insert 82 between the shaft portion 90 and a head portion 98, abuts a distal surface 100 on the core member 80 when the insert is threadedly connected to the core member. The core member 80 can be conventionally secured to the injection molding apparatus, particularly the adjacent mold plate M of the injection molding apparatus. Of course, as would be apparent to one skilled in the art, the exact design or configuration to accommodate the molding assemblies 38,40 and their components (including the core member 80) will depend on the injection molding apparatus.

The head portion 98 additionally includes a tool engaging area 102 adjacent the shoulder 96 and a ribbed retaining area 104 immediately forward of the area 102, both extending circumferentially about the insert 82. The tool engaging area 102, which can be tool flats, enables a mating tool (not shown) to be used in installing or removing the insert 82 from the core member 80. The ribbed retaining area 104 is used to retain the molded molding section 12 upon separation of the molding assemblies 38,40. More particularly, when the molding assemblies 38,40 are separated, the engagement between the molding section 12 and the ribbed area 104 provides sufficient resistance to maintain the molding section 12 on the insert 82.

To remove the molded molding section 12 from the insert 82 after the molding assemblies 38,40 are separated, the stripper member 84 is advanced in the direction of the mold section 12 (i.e., to the right in FIG. 2) and forcibly separates the mold section 12 from the insert 82. The resistance provided by the engagement of the molding section 12 to the ribbed area 104 is insufficient to resist the removal force of the stripper member 84. As illustrated, the core member 80 can include grooves 106 defined therein along at least a portion of a longitudinal extent thereof for venting of the mold cavity. The core member 80 can also include a tapered surface 108 that mates with a corresponding tapered surface 110 of the stripper member 84. The tapered engagement between the core member 80 and the stripper member 84 allows movement of the stripper member that does not substantially wear on the core member 80 and/or provide significant frictional resistance.

The core member 80 includes a cooling cavity 112 spaced from the bore 114 into which a cooling medium or fluid, such as water, is directed from cooling lines on the injection molding apparatus for cooling the molded molding section 12 after injection molding. The cooling cavity 72 of the water jacket 70 can also be fluidly connected to the cooling lines of the injection molding apparatus and, together with the cooling cavity 112, provide balanced cooling (i.e., cooling to both sides) to molding sections, such as molding section 12, formed in the cavity 36.

The non-optical tool insert molding surface 86, used to form the non-optical surface 22 opposite the optical surface 16, does not require an optical quality finish as it does not contact the polymerizable lens mixture in the lens casting process. Thus, the surface 86 does not require the same degree of polishing as the optical molding surface 56 which is used to form the optical surface 16 of mold section 12. However, some polishing or grinding may still be required. Due to the insert 82 and the core member 80 being separate components, they can more easily be formed of different materials. For example, the core member 80 could be formed of beryllium copper (BeCu), which has enhanced heat transfer characteristics, while the insert 82 is formed of a material that is more desirable to machine than BeCu from an environmental/biohazards standpoint, such as cooper, nickel or tin alloys. The molding surfaces 86,88 can be formed according to generally known methods, such as lathe cutting or electrodischarge machining.

The separation of the insert 82, which has the molding surface 86 thereon, and the core member 80, which has the cooling cavity 112 therein, enables the insert to be removed and replaced with a substitute insert relatively quickly and with significantly less downtime as might occur when changing a conventional unitary non-optical tool assembly. Because the cooling cavity 112 is located in a component (the core member 80) that is separate from the component (insert 82) having the non-optical molding surface 86, the insert can be changed to effect a change in the non-optical molding surface without shutting off the cooling lines or draining the cavity 112 and/or the cooling system of the injection molding apparatus. Moreover, removal of the insert and replacement of a substitute insert is much more rapid than removal of an entire core member.

Enabling rapid changes of the non-optical molding surface, via the insert 82 being separate and removably attached to the core member 80, allows for more frequent changes with less injection molding apparatus downtime. For example, a series of inserts, including insert 82, could be provided wherein the inserts have varying non-optical molding surfaces. When a change is made to the optical tool insert 44, such as occurs when desirable to mold molding sections capable of forming lenses of varying powers, a corresponding change can be made to the non-optical tooling assembly 40 without causing significant downtime of the injection molding apparatus. Such a corresponding change in the non-optical tooling assembly 40 may be desirable to optimize the wall thickness of the molding section 12 and/or to ensure that the wall thickness is relatively uniform.

The exemplary embodiment has been described with reference to one or more embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An apparatus for injection molding an ophthalmic lens mold, comprising:
an optical tool assembly having an optical molding surface for forming an optical surface of the ophthalmic lens mold; and
a non-optical tool assembly in opposed relation to said optical tool assembly and together therewith forms a mold cavity for forming the ophthalmic lens mold, said non-optical tool assembly including:
a core member, and
a non-optical tool insert removably secured to said core member, said non-optical tool insert having a first molding surface for forming a surface of the ophthalmic lens mold opposite the optical surface.

2. The apparatus of claim 1 wherein said core member includes a bore having internal threads which are threadedly engaged to threads on said non-optical tool insert which is received in said bore.

3. The apparatus of claim 2 wherein said core member includes a cooling cavity spaced from said bore and into which a cooling fluid may flow.

4. The apparatus of claim 2 wherein said non-optical tool insert includes tool flats for enabling a mating tool to be used in removing said non-optical tool insert from said core member.

5. The apparatus of claim 2 wherein said non-optical tool insert includes a ribbed retaining area defined circumferentially thereabout for retaining the ophthalmic lens mold thereon when said optical and non-optical tool assemblies are separated after molding of the ophthalmic lens mold.

6. The apparatus of claim 1 wherein said non-optical tooling assembly further includes:
a stripper member annularly received about said core member and moveable toward said optical tool assembly for removing a molded ophthalmic lens mold from said non-optical tool insert.

7. The apparatus of claim 6 wherein said core member includes a tapered surface that mates with a corresponding tapered surface of said stripper member.

8. The apparatus of claim 1 wherein said optical tool assembly includes an optical tool insert having said optical molding surface thereon that is removably secured to a cavity ring of said optical tool assembly, said cavity ring having a molding surface that forms an outer surface of a segment wall and an outer surface of a cylindrical wall of the ophthalmic lens mold.

9. The apparatus of claim 8 wherein said cavity ring defines a runner fluidly connected to said mold cavity for allowing resin to be injected into said mold cavity when injection molding the ophthalmic lens mold.

10. The apparatus of claim 1 wherein said non-optical tool insert includes a second molding surface that forms an inner surface of the segment wall and an inner surface of the cylindrical wall.

11. The apparatus of claim 1 wherein said mold cavity is shaped to form the ophthalmic lens mold as one of a posterior lens mold or an anterior lens mold.

12. The apparatus of claim 1 wherein said core member is formed of beryllium copper and said non-optical tool insert is formed of copper, nickel, or tin alloys, or a combination thereof.

13. The apparatus of claim 13 wherein said non-optical tool insert is formed of copper, nickel, or tin alloys, or a combination thereof.

14. An injection molding apparatus for forming a mold section which is subsequently used for forming an ophthalmic lens, comprising:
a cavity ring mounted to an associated first mold plate;
an optical tool insert removably mounted to said cavity ring, said optical tool insert having a molding surface with an optical quality finish;
a core member mounted to an associated second mold plate opposite the associated first mold plate; and
a non-optical tool insert removably mounted to said core member, said non-optical tool insert having a first molding surface for forming a surface of the mold section opposite the optical surface.

15. The injection molding apparatus of claim 14 wherein said cavity ring, said optical insert and said non-optical tool insert together form a mold cavity shaped to mold the mold section.

16. The injection molding apparatus of claim 14 wherein said core member includes a cooling cavity spaced from said non-optical tool insert.

17. The injection molding apparatus of claim 14 wherein said core member is beryllium copper for enhanced heat transfer and said non-optical tool insert is one of copper, nickel, tin or a combination thereof.

18. The injection molding apparatus of claim 14 wherein said core member includes a cooling cavity wherein a cooling fluid may flow, and said non-optical tool insert is changeable without disconnecting said cooling cavity from communication with said cooling fluid.

19. A non-optical tool assembly for use in an injection molding apparatus opposite an optical tool assembly to form a ophthalmic mold section, comprising:
a core member mounted to an associated mold plate of the injection molding apparatus and having a cooling cavity fluidly connected to at least one associated fluid line of the injection molding apparatus; and
a non-optical tool insert removably secured to said core member, said non-optical tool insert having a first molding surface for forming a surface of the ophthalmic mold section opposite an optical surface thereof.

20. The non-optical tool assembly of claim 19 wherein the core member is formed of beryllium copper and the non-optical tool insert is formed of a different material.

21. A method for forming an ophthalmic lens, comprising the steps of:
providing an injection molding apparatus having an optical tool assembly having an optical mold surface for forming an optical surface of an anterior mold section and a non-optical tool assembly in opposed relation to said optical tool assembly, said optical tool assembly and said non-optical tool assembly together forming a mold cavity, said non-optical mold assembly including a core member and a non-optical tool insert removably secured to said core member and having a first molding surface for forming a surface of said anterior mold section opposite said optical surface;
injection molding said anterior mold section in said mold cavity;
removing said molded anterior mold section from said mold cavity;
matching said anterior mold section with a posterior mold section; and
cast molding an ophthalmic lens between said anterior mold section and said posterior mold section.

22. An ophthalmic lens formed by the method of claim 21.
